(19) United States
(12) Patent Application Publication
(10) Pub. No.: US 2018/0082396 A1
(43) Pub. Date: Mar. 22, 2018

(54) DYNAMIC CAMERA PIPELINES

(71) Applicant: QUALCOMM Incorporated, San Diego, CA (US)

(72) Inventor: PuiYan Chung, San Diego, CA (US)

(21) Appl. No.: 15/268,348

(22) Filed: Sep. 16, 2016

(51) Int. Cl. G06T 1/20; H04N 1/60; G06T 7/40; G06T 7/00; G06T 5/00

(52) U.S. Cl. CPC G06T 1/20; H04N 1/6027; G06T 7/408; G06T 7/0085; G06T 2207/10028; G06T 5/003; G06T 5/002; G06T 2207/10024; G06T 7/0051

(57) ABSTRACT

Methods and apparatuses for a dynamic image pipeline are disclosed. In one aspect, an image pipeline includes a core pipeline configured to: receive an image from an image sensor, the received image being formatted in a first color space, and convert the received image into at least a second color space. The image pipeline may also include a plurality of detector circuits, each detector circuit configured to: receive the image from the core pipeline, and output at least one property related to a region of the received image based on the received image. The image pipeline may further include a plurality of effect circuits, each effect circuit configured to: receive output from at least one of the detector circuits, and apply an effect to the received image based on the output received from the at least one of the detector circuits.

### TECHNICAL FIELD

The present application relates generally to camera pipelines, and more specifically, to methods and systems for dynamically adjusting image pipelines for use by a camera or other imaging device.

### BACKGROUND

Imaging devices, such as digital cameras, may include one or more pipeline(s) which perform image processing on raw image data received from an image sensor. For example, a camera pipeline may be used to apply preprocessing to the received image data prior to storing the image data. This may allow the camera to perform a number of different preprocessing “effects” to the image data, such as correcting image defects and/or compressing the image to reduce the amount of data required to store the image. In order to perform the various preprocessing effects on the image data, the pipeline may convert the image data between various image formats in which the preprocessing effects may be more efficiently performed.

### SUMMARY

The systems, methods and devices of this disclosure each have several innovative aspects, no single one of which is solely responsible for the desirable attributes disclosed herein.

In one aspect, there is provided an image pipeline for an imaging device. The image pipeline comprising a core pipeline configured to: receive an image from an image sensor, the received image being formatted in a first color space, and convert the received image into at least a second color space. The image pipeline also comprising a plurality of detector circuits, each detector circuit configured to: receive the image from the core pipeline, and output at least one property related to a region of the received image based on the received image. The image pipeline further comprising a plurality of effect circuits, each effect circuit configured to: receive output from at least one of the detector circuits, and apply an effect to the received image based on the output received from the at least one of the detector circuits.

In another aspect, there is provided a method, operable by an imaging device including a dynamic camera pipeline comprising a core pipeline, a plurality of detector circuits and a plurality of effect circuits, the method comprising: receiving an image from an image sensor, the received image being formatted in a first color space; converting, using the core pipeline, the received image into at least a second color space; receiving, using the detector circuits, the image from the core pipeline; outputting, using the detector circuits, at least one property related to a region of the received image based on the received image; receiving, using the effect circuits, output from at least one of the detector circuits; and applying, using the effect circuits, an effect to the received image based on the output received from the at least one of the detector circuits.

In yet another aspect, there is provided an apparatus comprising means for receiving an image from an image sensor, the received image being formatted in a first color space; means for converting the received image into at least a second color space; means for receiving the image from the means for converting; a plurality of means for outputting at least one property related to a region of the received image based on the received image; means for receiving output from at least one of the means for outputting; and means for applying an effect to the received image based on the output received from the at least one of the means for outputting.

In still another aspect, there is provided a non-transitory computer readable storage medium having stored thereon instructions that, when executed, cause a processor of an imaging device to receive an image from an image sensor, the received image being formatted in a first color space; converting, using a core pipeline of the imaging device, the received image into at least a second color space; receiving, using a plurality of detector circuits of the imaging device, the image from the core pipeline; outputting, using the detector circuits, at least one property related to a region of the received image based on the received image; receiving, using a plurality of effect circuits of the imaging device, output from at least one of the detector circuits; and applying, using the effect circuits, an effect to the received image based on the output received from the at least one of the detector circuits.

### BRIEF DESCRIPTION OF THE DRAWINGS

FIG. 1A illustrates an example of an apparatus (e.g., a mobile communication device) that includes an imaging system that can record images of a scene in accordance with aspects of this disclosure.

FIG. 1B is a block diagram illustrating an example of an imaging device in accordance with aspects of this disclosure.

FIG. 2 is a block diagram illustrating an example of a dynamic image pipeline in accordance with aspects of this disclosure.

FIG. 3 is a block diagram illustrating a more detailed example of a dynamic image pipeline in accordance with aspects of this disclosure.

FIG. 4 is a flowchart illustrating an example method operable by an imaging device in accordance with aspects of this disclosure.

### DETAILED DESCRIPTION

Digital camera systems or other imaging devices may include a pipeline configured to apply preprocessing effects on a digital image received from an image sensor. In the traditional image pipeline, these preprocessing effects are selected by a designer of the digital camera system or imaging device and the hardware/programming of the pipeline is based on the structure of the imaging device at the time of manufacture. Thus, the pipeline may be considered “static” in that changes to the functionality (e.g., the preprocessing effects applied) of the pipeline cannot be altered once the imaging device has been manufactured.

However, image processing techniques are continually being developed and such new techniques may have distinct advantages over previously employed techniques. Thus, a static image pipeline may be less effective than a more recently developed image pipeline which includes later developed preprocessing techniques. Furthermore, certain conditions which may be affected by the environment in which an image is captured may relate better to certain preprocessing techniques than other techniques. Accordingly, it is desirable to have an image pipeline in which the applied preprocessing effect(s) may be adjusted, thereby providing a “dynamic” image pipeline.

The following detailed description is directed to certain specific embodiments. However, the described technology can be embodied in a multitude of different ways. It should be apparent that the aspects herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein.

Further, the systems and methods described herein may be implemented on a variety of different computing devices that host a camera. These include mobile phones, tablets, dedicated cameras, portable computers, photo booths or kiosks, personal digital assistants, ultra-mobile personal computers, mobile internet devices, security cameras, action cameras, drone cameras, automotive cameras, body cameras, head mounted cameras, etc. They may use general purpose or special purpose computing system environments or configurations. Examples of computing systems, environments, and/or configurations that may be suitable for use with the described technology include, but are not limited to, personal computers (PCs), server computers, hand-held or laptop devices, multiprocessor systems, microprocessor-based systems, programmable consumer electronics, network PCs, minicomputers, mainframe computers, distributed computing environments that include any of the above systems or devices, and the like.

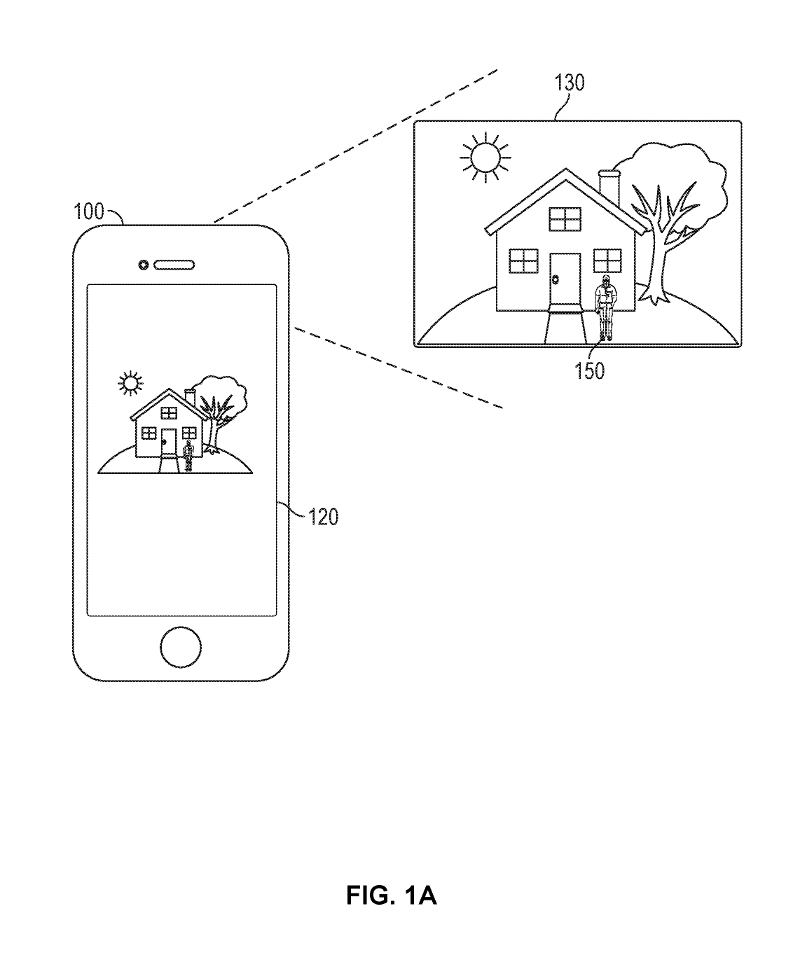

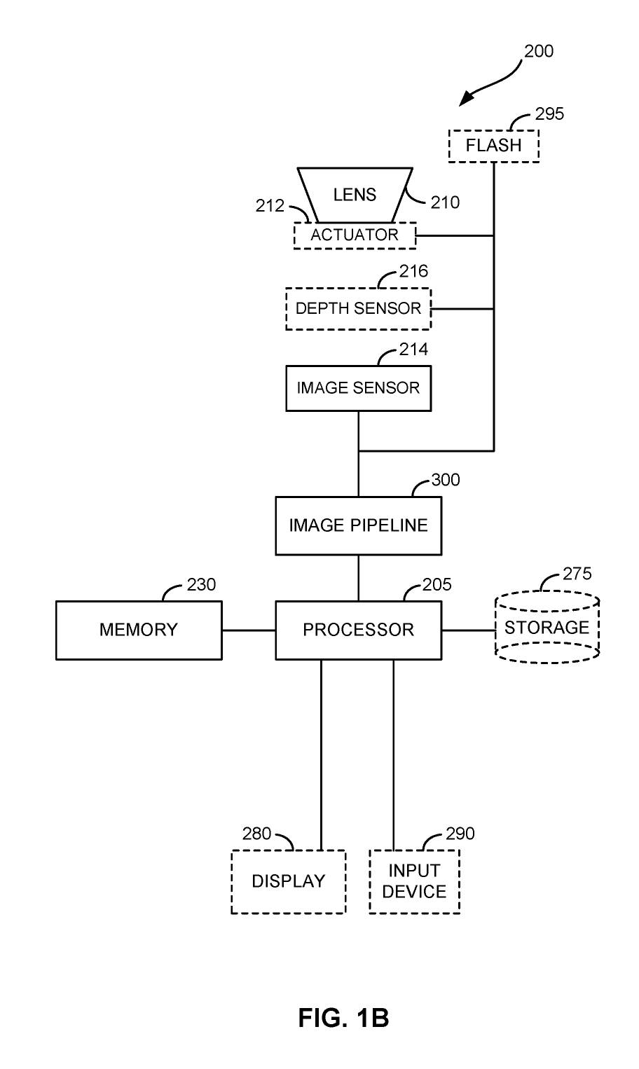

FIG. 1A illustrates an example of an apparatus (e.g., a mobile communication device) that includes an imaging system that can record images of a scene in accordance with aspects of this disclosure. The apparatus 100 includes a display 120. The apparatus 100 may also include a camera on the reverse side of the apparatus, which is not shown. The display 120 may display images captured within the field of view 130 of the camera. FIG. 1A shows an object 150 (e.g., a person) within the field of view 130 which may be captured by the camera.

FIG. 1B depicts a block diagram illustrating an example of an imaging device in accordance with aspects of this disclosure. The imaging device 200, also referred herein to interchangeably as a camera, may include an image pipeline 300, a processor 205 operatively connected to an image sensor 214, an optional depth sensor 216, a lens 210, an optional actuator 212, a memory 230, an optional storage 275, an optional display 280, an optional input device 290, and an optional flash 295. In this example, the illustrated memory 230 may store instructions to configure processor 205 to perform functions relating to the operation of the imaging device 200.

In an illustrative embodiment, light enters the lens 210 and is focused on the image sensor 214. In one aspect, the image sensor 214 utilizes a charge coupled device (CCD). In another aspect, the image sensor 214 utilizes either a complementary metal-oxide semiconductor (CMOS) or CCD sensor. The lens 210 is coupled to the actuator 212 and may be moved by the actuator 212 relative to the image sensor 214. The movement of the lens 210 with respect to the image sensor 214 may affect the focus of a captured image. The actuator 212 is configured to move the lens 210 in a series of one or more lens movements, e.g., during an auto-focus operation which may include adjusting the lens position to change the focus of an image. When the lens 210 reaches a boundary of its movement range, the lens 210 or actuator 212 may be referred to as saturated. In an illustrative embodiment, the actuator 212 is an open-loop voice coil motor (VCM) actuator. However, the lens 210 may be actuated by any method known in the art including closed-loop VCM, Micro-Electronic Mechanical System (MEMS), shape memory alloy (SMA), piezo-electric (PE), or liquid lens.

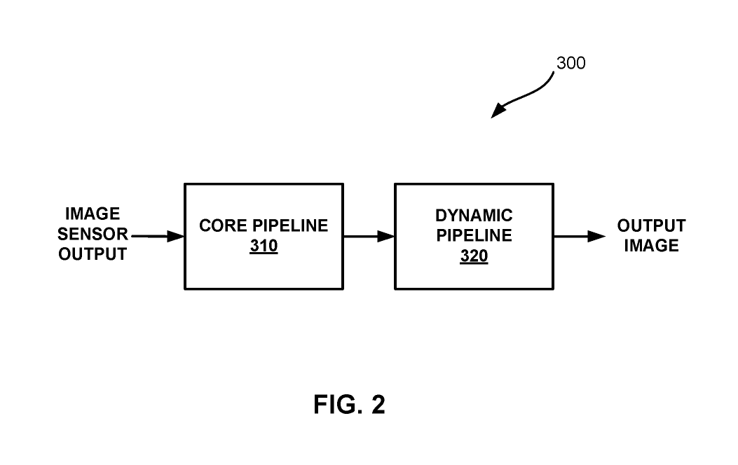

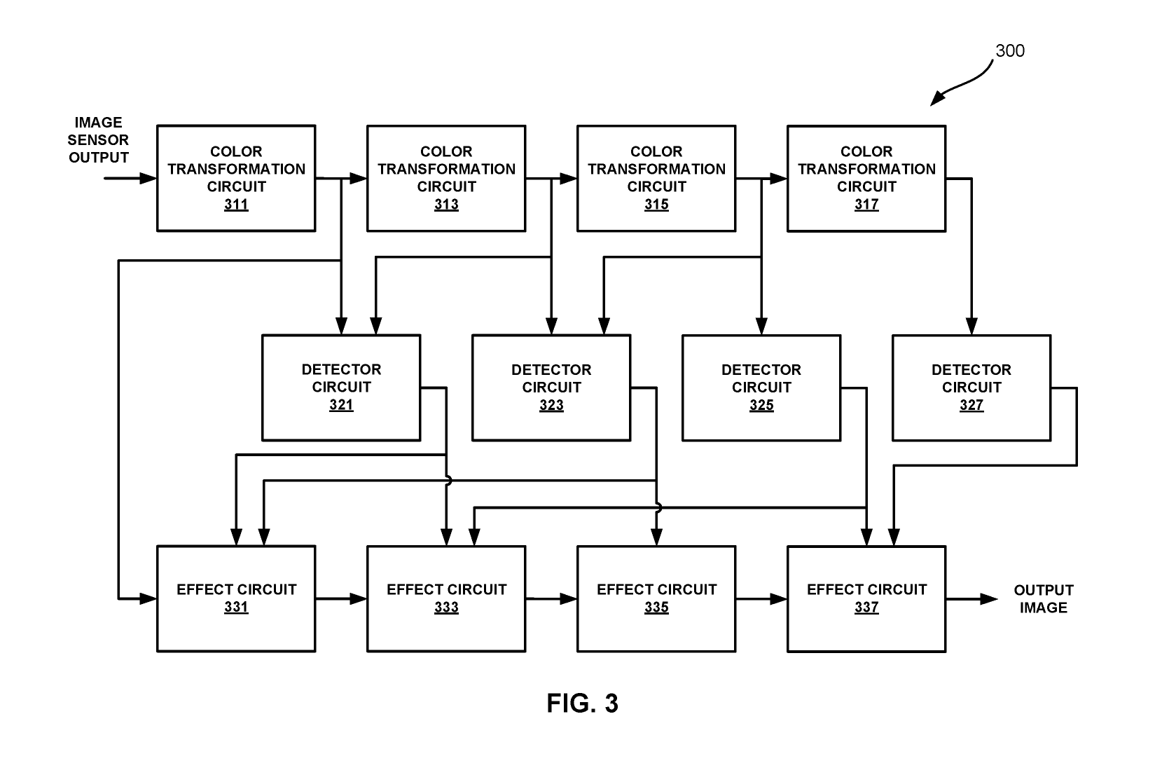

The image pipeline 300 may receive a raw image from the image sensor 204. The image pipeline may perform various preprocessing effects on the image received from the image sensor 204 prior to saving the image in the memory 230. The image pipeline 300 will be described in greater detail below in connection with FIGS. 2 and 3.

The depth sensor 216 is configured to estimate the depth of an object to be captured in an image by the imaging device 200. The depth sensor 216 may be configured to perform a depth estimation using any technique applicable to determining or estimating depth of an object or scene with respect to the imaging device 200. The display 280 is configured to display images captured via the lens 210 and the image sensor 214 and may also be utilized to implement configuration functions of the imaging device 200. In one implementation, the display 280 may be configured to display one or more regions of a captured image selected by a user, via an input device 290, of the imaging device 200. In some embodiments, the imaging device 200 may not include the display 280.

The input device 290 may take on many forms depending on the implementation. In some implementations, the input device 290 may be integrated with the display 280 so as to form a touch screen display. In other implementations, the input device 290 may include separate keys or buttons on the imaging device 200. These keys or buttons may provide input for navigation of a menu that is displayed on the display 280. In other implementations, the input device 290 may be an input port. For example, the input device 290 may provide for operative coupling of another device to the imaging device 200. The imaging device 200 may then receive input from an attached keyboard or mouse via the input device 290. In still other embodiments, the input device 290 may be remote from and communicate with the imaging device 200 over a communication network, e.g., a wireless network.

The memory 230 may be utilized by the processor 205 to store data dynamically created during operation of the imaging device 200. In some instances, the memory 230 may include a separate working memory in which to store the dynamically created data. For example, instructions stored in the memory 230 may be stored in the working memory when executed by the processor 205. The working memory may also store dynamic run time data, such as stack or heap data utilized by programs executing on processor 205. The storage 275 may be utilized to store data created by the imaging device 200. For example, images captured via image sensor 214 may be stored on storage 275. Like the input device 290, the storage 275 may also be located remotely, e.g., not integral with the imaging device 200, and may receive captured images via the communication network.

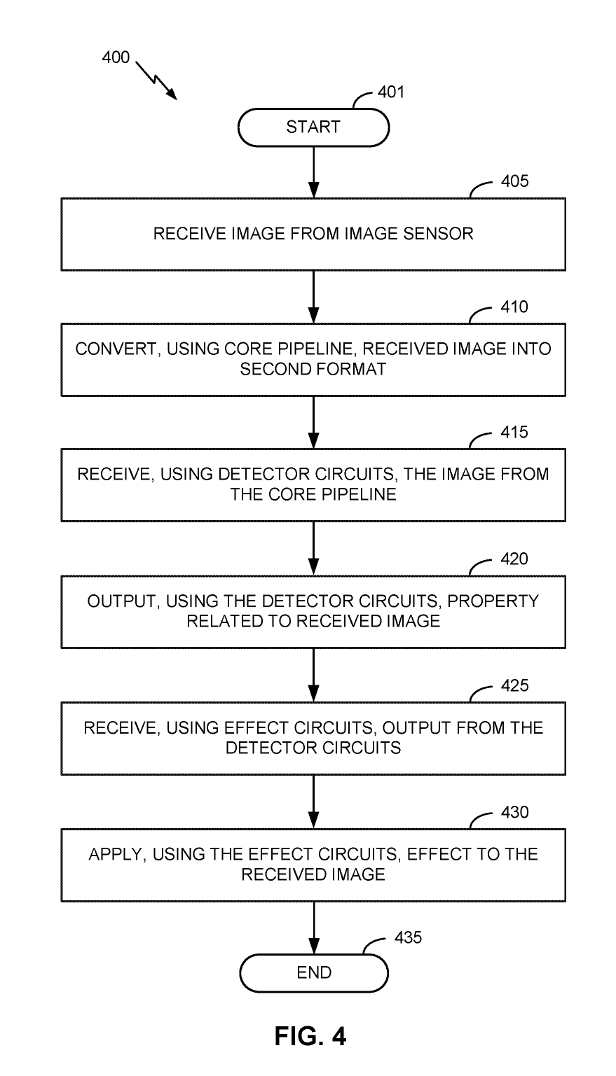

The memory 230 may be considered a computer readable medium and stores instructions for instructing the processor 205 to perform various functions in accordance with this disclosure. For example, in some aspects, memory 230 may be configured to store instructions that cause the processor 205 to perform method 400, or portion(s) thereof, as described below and as illustrated in FIG. 4. In related aspects, one or more of the components of the imaging device 200 may be arranged in a different manner an implemented as part of a system-on-chip (SoC), wherein the SoC that may include a central processing unit (CPU) that uses at least one reduced instruction set computing (RISC) instruction set. In further related aspects, the SoC may include multiple CPU cores and graphics processing unit (GPUs). In still further related aspects, the processor 205 and/or other component(s) of the imaging device 200 may comprise, or be part of, application specific integrated circuits (ASICs), field programmable gate arrays (FPGAs), discrete logic, software, hardware, firmware or any combinations thereof. In yet further related aspects, when the techniques are implemented partially in software, a device may store instructions for the software in a suitable, non-transitory computer-readable medium and execute the instructions in hardware using one or more processors to perform the techniques of this disclosure.

### Dynamic Image Pipelines

FIG. 2 is a block diagram illustrating an example of a dynamic image pipeline in accordance with aspects of this disclosure. The image pipeline 300 of FIG. 2 includes a core pipeline 310 and a dynamic pipeline 320. The core pipeline 310 receives an image (e.g., image sensor output) from an image sensor such as image sensor 214. In certain implementations, the core pipeline 310 may be a static pipeline which is fixed and cannot be reconfigured after manufacture of the image pipeline 300. The dynamic pipeline 320 may receive output from the core pipeline 310 and output an output image. Although not illustrated, the dynamic pipeline 320 may receive output from different stages of the core pipeline 310 in order to generate the output image. Additionally, the dynamic pipeline 320 may be reconfigured via by adjusting the connection between the various elements or stages of the dynamic pipeline as discussed in greater detail below.

The image pipeline 300 may be implemented as software executed by the processor 205 in response to instructions stored in the memory 230, in a separate processor such as an FPGA, via dedicated circuitry (e.g., analog circuits), or a combination thereof. When implemented via hardware separate from the processor 205 and specialized to the functionality of the pipeline, the image pipeline 300 may be more efficient than an image pipeline 300 implemented in the processor 205.

FIG. 3 is a block diagram illustrating a more detailed example of a dynamic image pipeline in accordance with aspects of this disclosure. The image pipeline 300 of FIG. 3 includes a plurality of color transformation circuits 311 to 317, a plurality of detector circuits 321 to 327, and a plurality of effect circuits 331 to 337. Although four circuits are illustrated for each of the color transformation circuits 311 to 317, the detector circuits 321 to 327, and the effect circuits 331 to 337, the number of each type of the circuits 311 to 337 may depend on the particular implementation of the image pipeline 300. In certain implementations, the color transformation circuits 311 to 317 may form the core pipeline 310, while the detector circuits 321 to 327 and the effect circuits 331 to 337 may form the dynamic pipeline 320.

One example of connections between the various circuits 311 to 337 is illustrated in FIG. 3, however, this disclosure is not limited thereto. In one implementation, the connections between the color transformation circuits 311 to 317 and the detector circuits 321 to 327 may be selected in order to adjust the parameters of the image which are detected by the detector circuits 321 to 327. That is, the image pipeline 300 may be configured to alter which of the detector circuits 321 to 327 receive the various color transformed outputs from the color transformation circuits 311 to 317 in order to adjust the information that can extracted from the image sensor output by the detector circuits 321 to 327. However, in other implementations, the information detected by the detector circuits 321 to 327 is fixed, and thus, the connection between the color transformation circuits 311 to 317 and the detector circuits 321 to 327 is also fixed.

Additionally, FIG. 3 illustrates an example of the connections between the detector circuits 321 to 327 and the effect circuits 331 to 337 in order to apply a certain number of preprocessing effects to the image. However, the image pipeline 300 may be subsequently configured to form any combination of outputs from the detector circuits 321 to 327 to the effect circuits 331 to 337 to apply different effects to the image sensor output. That is, the output of any one or more of the color transformation circuits 311 to 317 may be applied as the input to any one or more of the detector circuits 321 to 327 and the output of any one or more of the detector circuits 321 to 327 may be applied as the input to any one or more of the effect circuits 331 to 337. This may be accomplished, for example, by physical wiring connecting each of the color transformation circuits 311 to 317 to each of the detector circuits 321 to 327 to each of the effect circuits 331 to 337. Each physical wiring may include a switch, and thus, the various connections between the circuit 311 to 337 may be selected by turning-on or turning-off the switches. Accordingly, the effects which are applied to the image sensor output may be dynamically updated in order to change the effect applied to the image sensor output.

The image sensor output received by the color transformation circuit 311 may be formatted based on the type of the image sensor 214 used in the imaging device 200. For example, the image sensor 214 may be arranged in a Bayer pattern, resulting in an image that is typically demosaiced into a more common color format (also referred to as a color space) used for storage and/or display. As such, in certain implementations the color transformation circuit 311 may be a Bayer filter. Similar to color transformation circuit 311, each of the color transformation circuits 313 to 317 may convert the received image data from one color format to another color format. Accordingly, the output of each of the color transformation circuits 311 to 317 may be the image sensor output formatted in a different color format. As illustrated in FIG. 3, the color transformation circuits 311 to 317 may be arranged in series and successively convert the output of the previous color transformation circuit 311 to 317 to another color format. However, other arrangements such as a parallel configuration may also be employed in order to provide the image in a number of different color formats to the detector circuits 321. Examples of color formats which may be output from the color transformation circuits 311 to 317 include: RGB, YUV, YCbCr, etc.

Each of the detector circuits 321 to 327 receives output from at least one of the color transformation circuits 311 to 317. The detector circuit 321 to 327 may be configured to detect or extract certain information from the image sensor output which may be used by the effect circuits 331 to 337 as described below. Examples of the information which may be detected by the detector circuits 321 to 327 include: color, edge, texture, noise, flatness, statistics, outlines, shapes, distance, etc. However, other types of information may also be detected by the detector circuits 327, depending on the implementation. In an example implementation, detector circuit 321 may detect which of the pixels in the image sensor output are a certain color, e.g., which of the pixels are blue. In this implementation, the color transformation circuit 311 may output the image in RGB format to the detector circuit 321. The detector circuit 311 may, for example, determine that a given pixel is blue when the B value of the pixel is greater than a first threshold and when each of the R and G values of the pixel are respectively less that second and third thresholds. Other methods for detecting the color of the pixels in the image may also be performed. Additionally, the detector circuits 321 to 323 may receive output from more than one of the color transformation circuits 311 to 317 in order to detect other types of information from the image.

Similar to the detector circuits 321 to 327, each of the effect circuits 331 to 337 receives output from at least one of the detector circuits 321. Additionally, the first effect circuit 331 receives the image sensor output directly (not illustrated) or from at least one of the color transformation circuits 311 to 317. Each effect circuit 331 to 337 applies an effect to the image sensor output based on the output received from the detector circuits 321 to 327. Examples of effects which may be applied to the image sensor output include: saturation, hue, sharpen, denoise, contrast, brightness, smoothing, etc. However, other types of effects may also be applied to the image sensor output depending on the implementation. Additionally, the output of the detector circuits 321 to 327 may be multiplexed at the input of the corresponding effect circuit 331 to 337 to determine a region of the image on which to apply the corresponding effect. Each of the detector circuits 321 to 327 and the effect circuits 331 to 337 may operate at a frame level, a region level, a pixel level, or a combination thereof.

An example of a preprocessing effect for which the image pipeline 300 may be configured to perform is the denoising of a sky region of an image. The image pipeline 300 may be configured to perform this denoising effect by detecting the sky via a combination of the output from the detector circuits 321 to 327 and applying the denoising to the image via one of the effect circuits 331 to 337. For example, the image pipeline may be able to determine region(s) of the image as sky using detector circuit 321 to identify regions of the image which are blue, detector circuit 323 determining that the image was captured outdoors, and detector circuit 325 identifying region(s) of the image which are flat. By performing a logical “AND” of these three detector circuits 321, 323, and 325 in this example on a region-by-region or pixel-by-pixel basis, the effect circuit 331 may be able to perform denoising on a region of the image that has been identified as sky.

Another example of a preprocessing effect for which the image pipeline 300 may be configured to perform is the adjustment of the effect applied when an edge is detected in the image. For example, in a traditional image pipeline, when an edge is detected, the traditional image pipeline may adjust the sharpness of the edge. However, it may be desirable to perform other preprocessing effects on the edge, such as changing the contrast, the saturation, the hue, or any combination thereof. The selected preprocessing effects can be applied to a detected edge by supplying the output of one of the detector circuits 321 to 327 which is configured to detect edges to the selected effect circuits 331 to 337.

In one implementation, the selection of the connections between the various circuits 311 to 337 of the image pipeline 300 may be defined by a hardware element such as a register (not illustrated). That is, the register may define the state of a switch (e.g., a transistor) which can physically connect or disconnect each circuit 311 to 337 of the pipeline 300 from the remaining circuit(s) 311 to 337. The register may also define how the output from the detector circuits 321 to 327 are logically combined at the inputs of the effect circuit 331 to 337. In this implementation, the preprocessing effects may be selected by programming the register, which may be performed by the user of the imaging device 200 and/or by updating the firmware of the imaging device 200.

### Example Flowchart for Adjusting a Dynamic Camera Pipeline

FIG. 4 is a flowchart illustrating an example method operable by an imaging device in accordance with aspects of this disclosure. The steps illustrated in FIG. 4 may be performed by an imaging device 200 or component(s) thereof. For example, the method 400 may be performed by a processor 205 of the imaging device 200. For convenience, the method 400 is described as performed by the image pipeline 300 of the imaging device 200. The image pipeline 300 may also include a core pipeline 310, a plurality of detector circuits 321 to 327 and a plurality of effect circuits 331 to 337.

The method 400 begins at block 401. At block 405, the image pipeline 300 receives an image from an image sensor. The received image may be formatted in a first color space which may correspond to the format of the image sensor. At block 410, the image pipeline 300 converts, using the core pipeline 310, the received image into at least a second color space. In certain implementations, the core pipeline 310 may convert the received image into a plurality of different color spaces. At block 415, the image pipeline 310 receives, using the detector circuits 321 to 327, the image from the core pipeline 310. At block 420, the image pipeline 300 outputs, using the detector circuits 321 to 327, at least one property related to a region of the received image based on the received image. At block 425, the image pipeline 300 receives, using the effect circuits 331 to 337, output from at least one of the detector circuits 321 to 327. At block 430, the image processor 300 applies, using the effect circuits 331 to 337, an effect to the received image based on the output received from the at least one of the detector circuits 321 to 327. The method ends at block 435.

### Other Considerations

In some embodiments, the circuits, processes, and systems discussed above may be utilized in a wireless communication device, such as apparatus 100. The wireless communication device may be a kind of electronic device used to wirelessly communicate with other electronic devices. Examples of wireless communication devices include cellular telephones, smart phones, Personal Digital Assistants (PDAs), e-readers, gaming systems, music players, netbooks, wireless modems, laptop computers, tablet devices, etc.

The wireless communication device may include one or more image sensors, two or more image signal processors, and a memory including instructions or modules for carrying out the processes discussed above. The device may also have data, a processor loading instructions and/or data from memory, one or more communication interfaces, one or more input devices, one or more output devices such as a display device and a power source/interface. The wireless communication device may additionally include a transmitter and a receiver. The transmitter and receiver may be jointly referred to as a transceiver. The transceiver may be coupled to one or more antennas for transmitting and/or receiving wireless signals.

The wireless communication device may wirelessly connect to another electronic device (e.g., base station). A wireless communication device may alternatively be referred to as a mobile device, a mobile station, a subscriber station, a user equipment (UE), a remote station, an access terminal, a mobile terminal, a terminal, a user terminal, a subscriber unit, etc. Examples of wireless communication devices include laptop or desktop computers, cellular phones, smart phones, wireless modems, e-readers, tablet devices, gaming systems, etc. Wireless communication devices may operate in accordance with one or more industry standards such as the 3rd Generation Partnership Project (3GPP). Thus, the general term “wireless communication device” may include wireless communication devices described with varying nomenclatures according to industry standards (e.g., access terminal, user equipment (UE), remote terminal, etc.).

The functions described herein may be stored as one or more instructions on a processor-readable or computer-readable medium. The term “computer-readable medium” refers to any available medium that can be accessed by a computer or processor. By way of example, and not limitation, such a medium may include random-access memory (RAM), read-only memory (ROM), electrically erasable programmable read-only memory (EEPROM), flash memory or other optical disk storage, magnetic disk storage or other magnetic storage devices, or any other medium that can be used to store desired program code in the form of instructions or data structures and that can be accessed by a computer. Disk and disc, as used herein, includes compact disc (CD), laser disc, optical disc, digital versatile disc (DVD), floppy disk and Blu-ray® disc where disks usually reproduce data magnetically, while discs reproduce data optically with lasers. It should be noted that a computer-readable medium may be tangible and non-transitory. The term “computer-program product” refers to a computing device or processor in combination with code or instructions (e.g., a “program”) that may be executed, processed or computed by the computing device or processor. As used herein, the term “code” may refer to software, instructions, code or data that is/are executable by a computing device or processor.

The methods disclosed herein include one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

It should be noted that the terms “couple,” “coupling,” “coupled” or other variations of the word couple as used herein may indicate either an indirect connection or a direct connection. For example, if a first component is “coupled” to a second component, the first component may be either indirectly connected to the second component or directly connected to the second component. As used herein, the term “plurality” denotes two or more. For example, a plurality of components indicates two or more components.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

In the foregoing description, specific details are given to provide a thorough understanding of the examples. However, it will be understood by one of ordinary skill in the art that the examples may be practiced without these specific details. For example, electrical components/devices may be shown in block diagrams in order not to obscure the examples in unnecessary detail. In other instances, such components, other structures and techniques may be shown in detail to further explain the examples.

Headings are included herein for reference and to aid in locating various sections. These headings are not intended to limit the scope of the concepts described with respect thereto. Such concepts may have applicability throughout the entire specification.

It is also noted that the examples may be described as a process, which is depicted as a flowchart, a flow diagram, a finite state diagram, a structure diagram, or a block diagram. Although a flowchart may describe the operations as a sequential process, many of the operations can be performed in parallel, or concurrently, and the process can be repeated. In addition, the order of the operations may be re-arranged. A process is terminated when its operations are completed. A process may correspond to a method, a function, a procedure, a subroutine, a subprogram, etc. When a process corresponds to a software function, its termination corresponds to a return of the function to the calling function or the main function.

The previous description of the disclosed implementations is provided to enable any person skilled in the art to make or use the present disclosure. Various modifications to these implementations will be readily apparent to those skilled in the art, and the generic principles defined herein may be applied to other implementations without departing from the spirit or scope of the disclosure. Thus, the present disclosure is not intended to be limited to the implementations shown herein but is to be accorded the widest scope consistent with the principles and novel features disclosed herein.

What is claimed is:

1. An image pipeline for an imaging device, comprising:
a core pipeline configured to:
receive an image from an image sensor, the received image being formatted in a first color space, and
convert the received image into at least a second color space;
a plurality of detector circuits, each detector circuit configured to:
receive the image from the core pipeline, and
output at least one property related to a region of the received image based on the received image; and
a plurality of effect circuits, each effect circuit configured to:
receive output from at least one of the detector circuits, and
apply an effect to the received image based on the output received from the at least one of the detector circuits.

2. The image pipeline of claim 1, wherein each of the effect circuits is further configured to receive output from a different one of the detector circuits in response to a command received from a processor of the imaging device.

3. The image pipeline of claim 1, further comprising:
a register configured to: define connections between the detector circuits and the effect circuits, and be programmed to redefine the connections between the detector circuits and the effect circuits.

4. The image pipeline of claim 3, wherein the register is further configured to define logical operations between the outputs from the detector circuits to be supplied to the effect circuits, and be programmed to redefine logical operations between the outputs from the detector circuits to be supplied to the effect circuits.

5. The image pipeline of claim 1, wherein the core pipeline comprises a plurality of color transformation circuits, each color transformation circuit being configured to transform the received image between different color spaces.

6. The image pipeline of claim 5, further comprising:
a register configured to: define connections between the color transformation circuits and the detector circuits, and be programmed to redefine the connections between color transformation circuits and the detector circuits.

7. The image pipeline of claim 1, wherein each of the detector circuits is configured to detect at least one of the following properties of the received image: color, edge, texture, noise, flatness, statistics, outlines, shapes, and distance.

8. The image pipeline of claim 1, wherein each of the effect circuits is configured to apply at least one of the following effects to the received image: saturation, hue, sharpen, denoise, contrast, brightness, and smoothing.

9. A method, operable by an imaging device including a dynamic camera pipeline comprising a core pipeline, a plurality of detector circuits and a plurality of effect circuits, the method comprising:
receiving an image from an image sensor, the received image being formatted in a first color space;
converting, using the core pipeline, the received image into at least a second color space;
receiving, using the detector circuits, the image from the core pipeline;
outputting, using the detector circuits, at least one property related to a region of the received image based on the received image;
receiving, using the effect circuits, output from at least one of the detector circuits; and
applying, using the effect circuits, an effect to the received image based on the output received from the at least one of the detector circuits.

10. The method of claim 9, the imaging device further including a processor, the method further comprising receiving, using the effect circuits, output from a different one of the detector circuits in response to a command received from the processor.

11. The method of claim 9, the imaging device further comprising a register, the method further comprising:
defining, using the register, connections between the detector circuits and the effect circuits; and
receiving instructions to program the register to redefine the connections between the detector circuits and the effect circuits.

12. The method of claim 11, further comprising:
defining, using the register, logical operations between the outputs from the detector circuits to be supplied to the effect circuits; and
receiving instructions to program the register to redefine logical operations between the outputs from the detector circuits to be supplied to the effect circuits.

13. The method of claim 9, wherein the core pipeline comprises a plurality of color transformation circuits, the method further comprising transforming, using the color transformation circuits, the received image between different color spaces.

14. The method of claim 13, the imaging device further comprising a register, the method further comprising:
defining, using the register, connections between the color transformation circuits and the detector circuits; and
receiving instructions to program the register to redefine the connections between color transformation circuits and the detector circuits.

15. The method of claim 9, further comprising detecting, using the detector circuits, at least one of the following properties of the received image: color, edge, texture, noise, flatness, statistics, outlines, shapes, and distance.

16. The method of claim 9, further comprising applying, using the effect circuits, at least one of the following effects to the received image: saturation, hue, sharpen, denoise, contrast, brightness, and smoothing.

17. An apparatus, comprising:
means for receiving an image from an image sensor, the received image being formatted in a first color space;
means for converting the received image into at least a second color space;
means for receiving the image from the means for converting;
a plurality of means for outputting at least one property related to a region of the received image based on the received image;
means for receiving output from at least one of the means for outputting; and
means for applying an effect to the received image based on the output received from the at least one of the means for outputting.

18. The apparatus of claim 17, wherein the means for receiving output from the at least one of the means for outputting further comprise means for receiving output from a different one of the means for outputting in response to a command received from a processor.

19. The apparatus of claim 17, further comprising:
means for defining connections between the detector circuits and the effect circuits; and
means for receiving instructions to program the means for defining connections to redefine the connections between the detector circuits and the effect circuits.

20. The apparatus of claim 19, further comprising:
means for defining logical operations between the outputs from the detector circuits to be supplied to the effect circuits; and
means for receiving instructions to program the means for defining logical operations to redefine logical operations between the outputs from the detector circuits to be supplied to the effect circuits.

21. The apparatus of claim 17, wherein the means for converting comprises a plurality of means for converting the received image between different color spaces.

22. The apparatus of claim 21, further comprising:
means for defining connections between the color transformation circuits and the detector circuits; and
means for receiving instructions to program the means for defining connections to redefine the connections between color transformation circuits and the detector circuits.

23. The apparatus of claim 17, further comprising means for detecting at least one of the following properties of the received image: color, edge, texture, noise, flatness, statistics, outlines, shapes, and distance.

24. A non-transitory computer readable storage medium having stored thereon instructions that, when executed, cause a processor of an imaging device to:
receive an image from an image sensor, the received image being formatted in a first color space;
converting, using a core pipeline of the imaging device, the received image into at least a second color space;
receiving, using a plurality of detector circuits of the imaging device, the image from the core pipeline;
outputting, using the detector circuits, at least one property related to a region of the received image based on the received image;
receiving, using a plurality of effect circuits of the imaging device, output from at least one of the detector circuits; and
applying, using the effect circuits, an effect to the received image based on the output received from the at least one of the detector circuits.

25. The non-transitory computer readable storage medium of claim 24, further having stored thereon instructions that, when executed, cause the processor to receive, using the effect circuits, output from a different one of the detector circuits in response to a command received from a processor of the imaging device.

26. The non-transitory computer readable storage medium of claim 24, further having stored thereon instructions that, when executed, cause the processor to:
define, using a register of the imaging device, connections between the detector circuits and the effect circuits; and
receive instructions to program the register to redefine the connections between the detector circuits and the effect circuits.

27. The non-transitory computer readable storage medium of claim 26, further having stored thereon instructions that, when executed, cause the processor to:
define, using the register, logical operations between the outputs from the detector circuits to be supplied to the effect circuits; and
receive instructions to program the register to redefine logical operations between the outputs from the detector circuits to be supplied to the effect circuits.

28. The non-transitory computer readable storage medium of claim 24, further having stored thereon instructions that, when executed, cause the processor to the method further comprising transforming, using a plurality of color transformation circuits of the core pipeline, the received image between different color spaces.

29. The non-transitory computer readable storage medium of claim 28, further having stored thereon instructions that, when executed, cause the processor to:
define, using a register of the imaging device, connections between the color transformation circuits and the detector circuits; and
receive instructions to program the register to redefine the connections between color transformation circuits and the detector circuits.

30. The non-transitory computer readable storage medium of claim 24, further having stored thereon instructions that, when executed, cause the processor to detect, using the detector circuits, at least one of the following properties of the received image: color, edge, texture, noise, flatness, statistics, outlines, shapes, and distance.
